(19) United States
(12) Patent Application Publication
(10) Pub. No.: US 2026/0289469 A1
(43) Pub. Date: Sep. 24, 2026

(54) INFORMATION PROCESSING APPARATUS, INFORMATION PROCESSING METHOD, AND NON-TRANSITORY COMPUTER READABLE MEDIUM

(71) Applicant: NEC Corporation, Tokyo (JP)

(72) Inventors: Marina MITO, Tokyo (JP); Tomoko INAGUMA, Tokyo (JP)

(73) Assignee: NEC Corporation, Tokyo (JP)

(21) Appl. No.: 19/563,052

(22) Filed: Mar. 11, 2026

(30) Foreign Application Priority Data
Mar. 18, 2025 (JP) 2025-044035

(51) Int. Cl. G06Q 10/0639; G06V 40/16; G10L 25/63

(52) U.S. Cl. CPC G06Q 10/0639; G06V 40/165; G10L 25/63

(57) ABSTRACT

An information processing apparatus comprising: at least one memory configured to store one or more instructions; and at least one processor configured to execute the one or more instructions to: acquire a result of an engagement survey; acquire reliability of an answer by a subject of the engagement survey; acquire an issue based on text data obtained from the subject; generate a factor analysis result for a factor affecting an engagement by using the result, the reliability, and the issue; and output the factor analysis result.

### INCORPORATION BY REFERENCE

This application is based upon and claims the benefit of priority from Japanese patent application No. 2025-044035, filed on Mar. 18, 2025, the disclosure of which is incorporated herein in its entirety by reference.

### TECHNICAL FIELD

The present disclosure relates to an information processing apparatus, an information processing method, and an information processing program.

### BACKGROUND ART

A technique for estimating engagement of a worker is known. An example of the technique for estimating engagement is a technique described in WO 2024/106307 A1, for example.

### SUMMARY

In the technique described in WO 2024/106307 A1, there is a problem that a factor of improvement or decrease in engagement cannot be grasped.

The present disclosure has been made in view of the above problem, and an example object thereof is to provide a technique capable of grasping a factor of improvement or decrease in engagement.

An information processing apparatus according to an example aspect of the present disclosure includes at least one memory configured to store one or more instructions; and at least one processor configured to execute the one or more instructions to: acquire a result of an engagement survey; acquire reliability of an answer by a subject of the engagement survey; acquire an issue based on text data obtained from the subject; generate a factor analysis result for a factor affecting an engagement by using the result, the reliability, and the issue; and output the factor analysis result.

An information processing method according to an example aspect of the present disclosure includes acquiring a result of an engagement survey; acquiring a reliability of an answer by a subject of the engagement survey; acquiring an issue based on text data obtained from the subject; generating a factor analysis result for a factor affecting an engagement by using the result, the reliability, and the issue; and outputting the factor analysis result.

A non-transitory storage medium storing a program according to an example aspect of the present disclosure is for causing a computer to acquire a result of an engagement survey; acquire a reliability of an answer by a subject of the engagement survey; acquire an issue based on text data obtained from the subject; generate a factor analysis result for a factor affecting an engagement by using the result, the reliability, and the issue; and output the factor analysis result.

According to an example aspect of the present disclosure, there is an example effect that it is possible to provide a technique capable of grasping the factor of improvement or decrease in engagement.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating a configuration of an information processing device according to the present disclosure;

FIG. 2 is a flow diagram illustrating a flow of an information processing method according to the present disclosure;

FIG. 3 is a block diagram illustrating an example of a configuration of an information processing system according to the present disclosure;

FIG. 4 is a block diagram illustrating an example of a configuration of a terminal according to the present disclosure;

FIG. 5 is a block diagram illustrating an example of a configuration of a reliability calculation device according to the present disclosure;

FIG. 6 is a block diagram illustrating an example of a configuration of an issue extraction device according to the present disclosure;

FIG. 7 is a block diagram illustrating an example of a configuration of a feature value extraction device according to the present disclosure;

FIG. 8 is a block diagram illustrating an example of a configuration of an engagement analysis server according to the present disclosure;

FIG. 9 is a sequence diagram illustrating an example of a flow of a data collection method according to the present disclosure;

FIG. 10 is a diagram illustrating an example of survey result data according to the present disclosure;

FIG. 11 is a diagram illustrating an example of answer time and cursor data;

FIG. 12 is a flow diagram illustrating an example of a flow of reliability calculation processing according to the present disclosure;

FIG. 13 is a diagram illustrating an example of an analysis result of an answer time and cursor data according to the present disclosure;

FIG. 14 is a diagram illustrating an example of an analysis result of an emotion according to the present disclosure;

FIG. 15 is a diagram illustrating an example of an analysis result of a line of sight according to the present disclosure;

FIG. 16 is a diagram illustrating an example of an analysis result of a blink according to the present disclosure;

FIG. 17 is a diagram illustrating an example of reliability according to the present disclosure;

FIG. 18 is a flow diagram illustrating an example of a flow of issue extraction processing method according to the present disclosure;

FIG. 19 is a diagram illustrating an example of the analysis result of the emotion according to the present disclosure;

FIG. 20 is a diagram illustrating an example of a text according to the present disclosure;

FIG. 21 is a diagram illustrating an example of an analysis result of intonation according to the present disclosure;

FIG. 22 is a diagram illustrating an example of an issue according to the present disclosure;

FIG. 23 is a sequence diagram illustrating an example of a flow of a factor analysis method according to the present disclosure;

FIG. 24 is a diagram illustrating an example of a factor analysis result according to the present disclosure;

FIG. 25 is a diagram illustrating an example of the factor analysis result according to the present disclosure; and

FIG. 26 is a block diagram illustrating a configuration of a computer that functions as the information processing device according to the present disclosure.

### EXAMPLE EMBODIMENTS

Hereinafter, example embodiments of the present disclosure will be exemplified. However, the present disclosure is not limited to the following illustrative example embodiments, and various modifications can be made within a scope described in the claims. For example, example embodiments obtained by appropriately combining techniques (some or all of things or methods) adopted in the following illustrative example embodiments can also be included in the scope of the present disclosure. Example embodiments obtained by appropriately omitting some of the techniques adopted in the following illustrative example embodiments can also be included in the scope of the present disclosure. Effects mentioned in the following illustrative example embodiments are examples of effects expected in the illustrative example embodiments, and do not define extension of the present disclosure. That is, example embodiments that do not provide the effects mentioned in each of the illustrative example embodiments described below can also be included in the scope of the present disclosure.

### FIRST ILLUSTRATIVE EXAMPLE EMBODIMENT

A first illustrative example embodiment that is an example of the example embodiments of the present disclosure will be described in detail with reference to the drawings. The present illustrative example embodiment is a basic form of each illustrative example embodiment to be described later. An application range of each technique adopted in the present illustrative example embodiment is not limited to the present illustrative example embodiment. That is, each technique adopted in the present illustrative example embodiment can also be adopted in another illustrative example embodiment included in the present disclosure within a range in which no particular technical problem occurs. Furthermore, each technique illustrated in the drawings referred to for describing the present illustrative example embodiment can also be adopted in another illustrative example embodiment included in the present disclosure within a range in which no particular technical problem occurs.

### Configuration of Information Processing Device

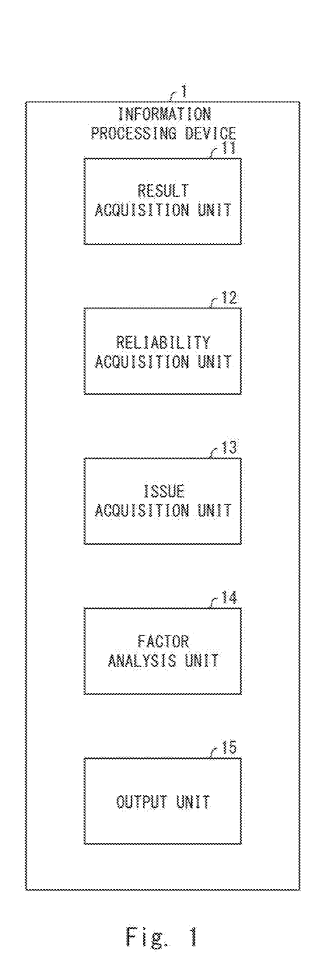

A configuration of an information processing device 1 will be described with reference to FIG. 1. FIG. 1 is a block diagram illustrating the configuration of the information processing device 1. As illustrated in FIG. 1, the information processing device 1 includes a result acquisition unit 11, a reliability acquisition unit 12, an issue acquisition unit 13, a factor analysis unit 14, and an output unit 15. The result acquisition unit 11 acquires a result of an engagement survey. The reliability acquisition unit 12 acquires reliability of an answer by a subject of the engagement survey. The issue acquisition unit 13 acquires an issue obtained by an interaction with the subject. The factor analysis unit 14 analyzes a factor of improvement or decrease in engagement of the subject by using the result, the reliability, and the issue. The output unit 15 outputs an analysis result by the factor analysis unit 14.

### Effects of Information Processing Device

As described above, the information processing device 1 adopts a configuration including the result acquisition unit 11 for acquiring a result of an engagement survey, the reliability acquisition unit 12 for acquiring reliability of an answer by a subject of the engagement survey, the issue acquisition unit 13 for acquiring an issue obtained by an interaction with the subject, the factor analysis unit 14 for analyzing a factor of improvement or decrease in engagement of the subject by using the result, the reliability, and the issue, and the output unit 15 for outputting an analysis result by the factor analysis unit 14. According to the information processing device 1, it is therefore possible to obtain an effect of being able to grasp the factor of improvement or decrease in engagement.

### Flow of Information Processing Method

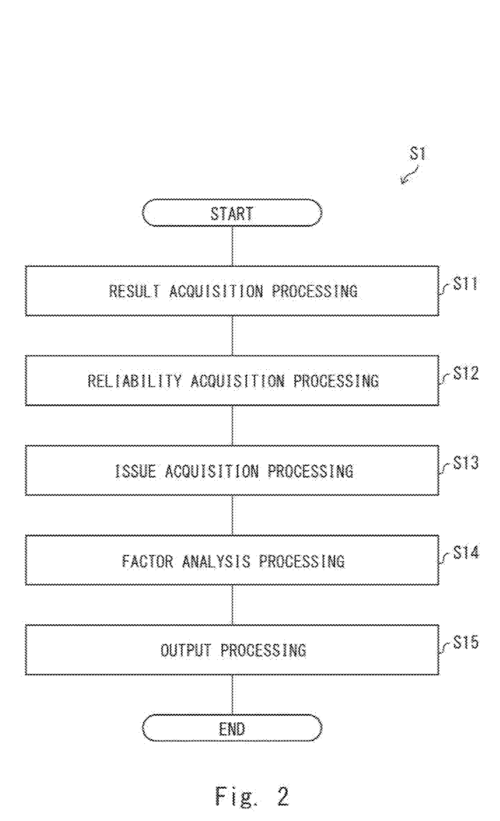

A flow of an information processing method S1 will be described with reference to FIG. 2. FIG. 2 is a flow diagram illustrating the flow of the information processing method S1. As illustrated in FIG. 2, the information processing method S1 includes result acquisition processing S11, reliability acquisition processing S12, issue acquisition processing S13, factor analysis processing S14, and output processing S15.

In the result acquisition processing S11, at least one processor acquires a result of an engagement survey. In the reliability acquisition processing S12, the at least one processor acquires reliability of an answer by a subject of the engagement survey. In the issue acquisition processing S13, the at least one processor acquires an issue obtained by an interaction with the subject. In the factor analysis processing S14, the at least one processor analyzes a factor of improvement or decrease in engagement of the subject by using the result, the reliability, and the issue. In the output processing S15, the at least one processor outputs an analysis result by the factor analysis processing.

### Effects of Information Processing Method

As described above, in the information processing method S1, a configuration is adopted including the result acquisition processing S11 in which at least one processor acquires a result of an engagement survey, the reliability acquisition processing S12 in which the at least one processor acquires reliability of an answer by a subject of the engagement survey, the issue acquisition processing S13 in which the at least one processor acquires an issue obtained by an interaction with the subject, the factor analysis processing S14 in which the at least one processor analyzes a factor of improvement or decrease in engagement of the subject by using the result, the reliability, and the issue, and the output processing S15 in which the at least one processor outputs an analysis result by the factor analysis processing. According to the information processing method S1, it is therefore possible to obtain an effect of being able to grasp the factor of improvement or decrease in engagement.

### SECOND ILLUSTRATIVE EXAMPLE EMBODIMENT

A second illustrative example embodiment that is an example of the example embodiments of the present disclosure will be described in detail with reference to the drawings. Components having the same functions as the components described in the above-described illustrative example embodiment are denoted by the same reference signs, and the description thereof will be appropriately omitted. An application range of each technique adopted in the present illustrative example embodiment is not limited to the present illustrative example embodiment. That is, each technique adopted in the present illustrative example embodiment can also be adopted in another illustrative example embodiment included in the present disclosure within a range in which no particular technical problem occurs. Each technique illustrated in each of the drawings referred to for describing the present illustrative example embodiment can be adopted in another illustrative example embodiment included in the present disclosure within the scope in which no particular technical problem occurs.

### Configuration of Information Processing System

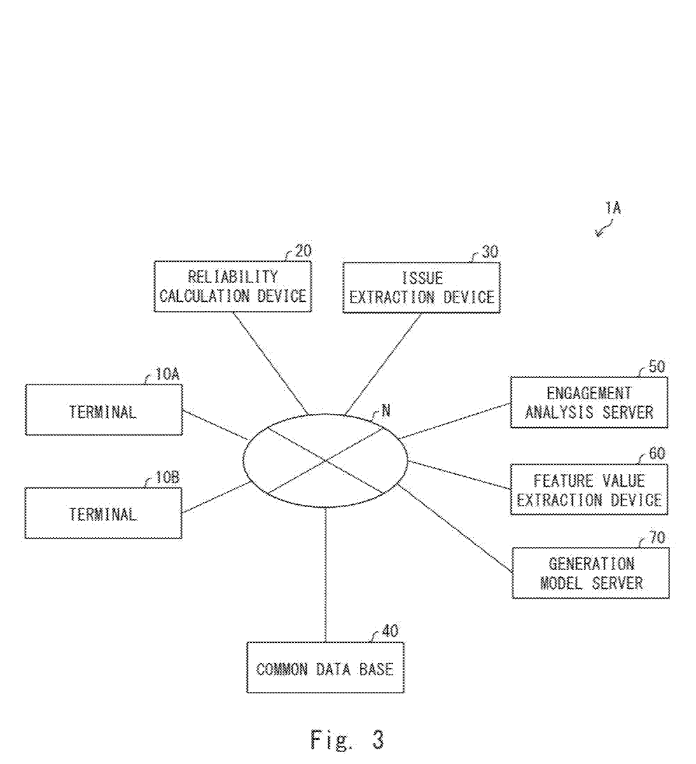

A configuration of an information processing system 1A will be described with reference to FIG. 3. FIG. 3 is a block diagram illustrating an example of the configuration of the information processing system 1A. The information processing system 1A is a system that analyzes an improvement factor and a decrease factor of engagement and presents an analysis result to a client, or plans a measure for improving engagement and presents the measure to the client. Here, the engagement represents employee's willingness to contribute to the organization. The client is a user of the information processing system 1A, and is, for example, an employee in charge of analyzing engagement and planning measures.

In the example of FIG. 3, the information processing system 1A includes a terminal 10A, a terminal 10B, a reliability calculation device 20, an issue extraction device 30, a common data base 40, an engagement analysis server 50, a feature value extraction device 60, and a generation model server 70. The terminal 10A, the terminal 10B, the reliability calculation device 20, the issue extraction device 30, the common data base 40, the engagement analysis server 50, the feature value extraction device 60, and the generation model server 70 are connected to be able to communicate with each other via a communication line N. Although a specific configuration of the communication line N does not limit the present example embodiment, the communication line N is, for example, a wireless Local Area Network (LAN), a wired LAN, a Wide Area Network (WAN), a public line network, a mobile data communication network, or a combination thereof. The engagement analysis server 50 and the feature value extraction device 60 are examples of an information processing device according to the present disclosure.

The terminal 10A is a terminal used by a subject of an engagement survey. The subject operates the terminal 10A to create an answer to the engagement survey. The engagement survey is a survey for quantifying and grasping engagement. For example, in order to grasp levels of motivation and engagement of an employee, the will of the employee to work, the satisfaction with the workplace environment, and the like are measured. An engagement score obtained by quantification of engagement is calculated based on the answer of the subject to the engagement survey. For example, the will of the employee to work and the degree of attachment to the company are calculated. An engagement survey result is, for example, a set of answers of the subject to a plurality of questions. The terminal 10A is, for example, a personal computer such as a laptop computer, a tablet terminal, or a smartphone.

The terminal 10A generates record data in which recording (video recording, audio recording, or the like) of an interaction with the subject is performed. Examples of the interaction with the subject include a one-on-one meeting between the subject and the group leader. The interaction with the subject may be performed face-to-face, or may be performed by communication such as a video phone. The record data is, for example, voice data, image data, or a combination thereof. The terminal that generates the record data may be the same as or different from the terminal used for the engagement survey.

The terminal 10B is a terminal used by a client that performs analysis and the like of engagement, and is, for example, a personal computer such as a laptop computer, a tablet terminal, or a smartphone. In the following description, in a case where it is not necessary to distinguish the terminal 10A and the terminal 10B from each other, they are referred to as “terminals 10”.

The reliability calculation device 20 is a device that calculates reliability of the answer of the subject to the engagement survey. The reliability is an index indicating a degree of reliability. The issue extraction device 30 has a function of extracting an issue at a site from content of the interaction with the subject. The issue at the site is worry or dissatisfaction that the subject has with the organization, and is, for example, “a number of drinking parties” or “anxiety about skills that can be acquired in the current work”.

The common data base 40 collects various types of data such as a result of the engagement survey. Examples of the data collected by the common data base 40 include data indicating the result of the engagement survey, reliability of the answer of the engagement survey, an issue obtained by the interaction with the subject, and the like. The data collected by the common data base 40 is used to analyze a factor of improvement or decrease in engagement. Examples of the data include employee satisfaction survey data (workplace environment, relationship with a colleague or a boss, and the like), an attendance/absence rate and a leave acquisition rate, a productivity index (performance and target achievement rate of an individuals and a team), and a frequency and quality of a one-on-one meeting (communication status between a boss and a subordinate). The data collected by the common data base 40 is not limited thereto. Video data of the one-on-one meeting may be included.

The engagement analysis server 50 performs analysis of engagement, based on a request from the terminal 10B. At this time, the engagement analysis server 50 performs analysis of engagement by using a feature value extracted by the feature value extraction device 60 described later and a generation model of the generation model server 70 described later. The engagement analysis server 50 transmits the analysis result to the terminal 10B.

The feature value extraction device 60 extracts a feature value from data accumulated in the common data base 40, based on an instruction from the engagement analysis server 50, and transmits the extracted feature value to the engagement analysis server 50. The generation model server 70 stores the generation model used for analysis of engagement. Note that “the generation model server 70 stores the generation model” means that parameters defining the generation model are stored in a storage unit of the generation model server 70.

The generation model is a model generated by machine learning, and generates content such as text. Input to the generation model includes, for example, a prompt for giving an instruction to analyze a factor of decrease in engagement and a countermeasure therefor. Output from the generation model is, for example, content indicating an analysis result of the factor of the decrease in the engagement and content of the countermeasure. The content is not limited to text, and may include image data, voice data, or moving image data. Examples of the generation model include, but are not limited to, a generative AI that automatically generates new digital content such as text, image, voice, and video, or the generative AI finely tuned.

The configuration of the information processing system 1A is not limited to that illustrated in FIG. 3. For example, in the example of FIG. 3, one terminal 10A and one terminal 10B are illustrated, but the number of terminals 10A and terminals 10B included in the information processing system 1A may be larger than that. A configuration may be adopted in which at least one of the reliability calculation device 20, the issue extraction device 30, the common data base 40, the engagement analysis server 50, the feature value extraction device 60, or the generation model server 70 is implemented by cooperation of a plurality of devices. For example, the function of the reliability calculation device 20 may be implemented by cooperation of a plurality of devices connected to each other via a communication network.

At least any two of the reliability calculation device 20, the issue extraction device 30, the common data base 40, the engagement analysis server 50, the feature value extraction device 60, or the generation model server 70 may be configured as one device. For example, the reliability calculation device 20 and the issue extraction device 30 may be configured as one device instead of separate devices. For example, the reliability calculation device 20, the issue extraction device 30, and the engagement analysis server 50 may be configured as one device.

### Configuration of Terminal

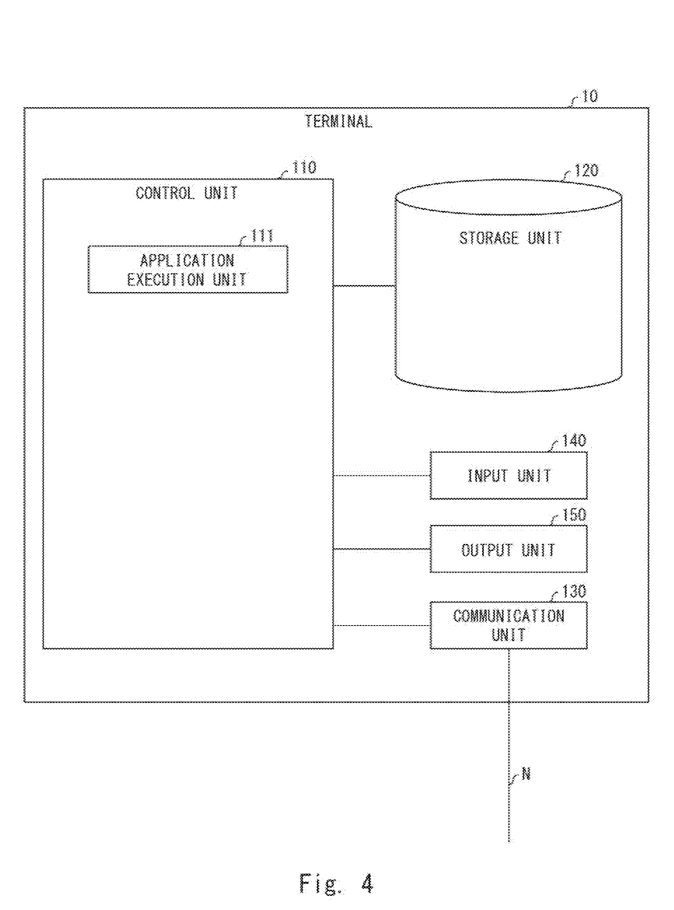

FIG. 4 is a block diagram illustrating an example of a configuration of the terminal 10. The terminal 10 includes a control unit 110, a storage unit 120, a communication unit 130, an input unit 140, and an output unit 150. The control unit 110 executes commands of a computer program stored in the storage unit 120. The storage unit 120 stores the commands of the computer program executed by the control unit 110.

The communication unit 130 communicates with a device outside the terminal 10 via the communication line N. The communication unit 130 transmits data supplied from the control unit 110 to another device, and supplies data received from another device to the control unit 110.

The input unit 140 is configured to receive an input to the terminal 10, and includes, for example, an input device such as a keyboard, a mouse, a touch panel, a camera, or a microphone. The input unit 140 may be configured to receive data from the input device via, for example, an interface such as a Universal Serial Bus (USB).

The output unit 150 is configured to perform output from the user terminal 10, and includes, for example, an output device such as a display, a printer, a touch panel, or a speaker. The output unit 150 may have a configuration including an interface such as a USB, for example, and may be configured to output data to the output device via the interface.

The control unit 110 includes an application execution unit 111. The application execution unit 111 executes an application used for performing an engagement survey or engagement analysis. Examples of the application include, but are not limited to, a general-purpose web browser. The application may be, for example, a dedicated application for performing an engagement survey or engagement analysis.

### Configuration of Reliability Calculation Device

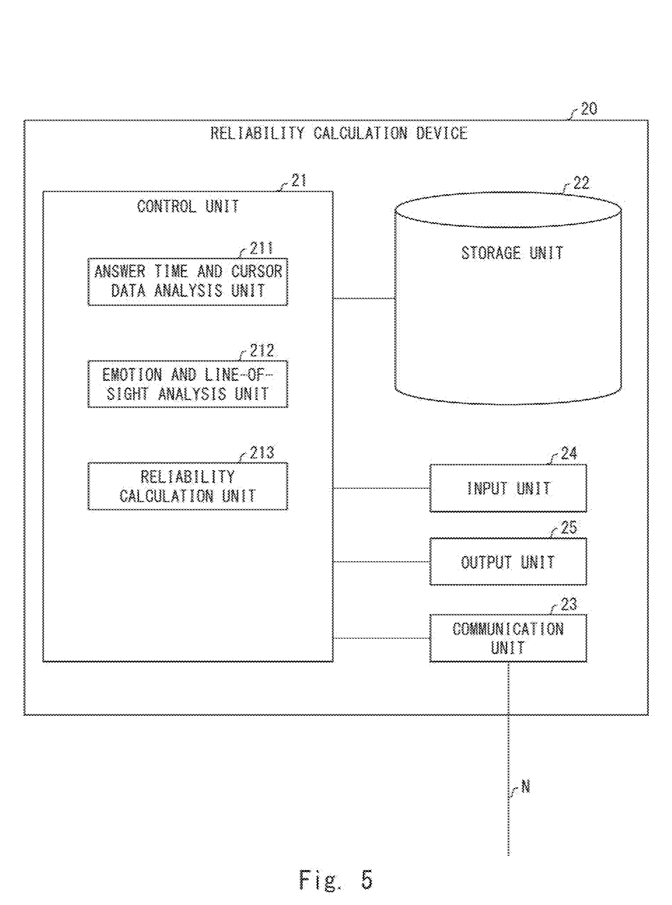

FIG. 5 is a block diagram illustrating a configuration of the reliability calculation device 20. The reliability calculation device 20 includes a control unit 21, a storage unit 22, a communication unit 23, an input unit 24, and an output unit 25. The control unit 21 executes commands of a computer program stored in the storage unit 22. The storage unit 22 stores the commands of the computer program executed by the control unit 21.

The communication unit 23 communicates with a device outside the reliability calculation device 20 via the communication line N. The communication unit 23 transmits data supplied from the control unit 21 to another device, and supplies data received from another device to the control unit 21.

The input unit 24 is configured to receive an input to the reliability calculation device 20, and includes, for example, an input device such as a keyboard, a mouse, a touch panel, a camera, or a microphone. The input unit 24 may be configured to receive data from the input device via, for example, an interface such as a USB.

The output unit 25 is configured to perform output from the reliability calculation device 20, and includes, for example, an output device such as a display, a printer, a touch panel, or a speaker. The output unit 25 may have a configuration including an interface such as a USB, for example, and may be configured to output data to the output device via the interface.

The control unit 21 includes an answer time and cursor data analysis unit 211, an emotion and line-of-sight analysis unit 212, and a reliability calculation unit 213. The answer time and cursor data analysis unit 211 calculates an answer time for each question included in the engagement survey by referring to an operation history of the terminal 10A by a subject who is creating an answer to the engagement survey. More specifically, the answer time and cursor data analysis unit 211 calculates the answer time of each question by specifying a question relevant to a position of the cursor for each unit time, for example. However, calculation processing for the answer time for each question is not limited to the example described above.

The emotion and line-of-sight analysis unit 212 analyzes transition of an emotion of the subject by referring to image data obtained by imaging of the subject who is answering the engagement survey. Examples of a method of analyzing an emotion include, but are not limited to, a method of analyzing a shape and movement of a face by using a feature point of the face detected from an image and texture information on the image, a method of classifying an emotion by an output obtained by inputting image data into a classification model generated by supervised machine learning, and the like.

The emotion and line-of-sight analysis unit 212 analyzes transition of a line of sight of the subject by referring to the image data. Examples of a method of analyzing the line of sight include, but are not limited to, a method of detecting a change in a face, a position of a pupil, and a movement of an eye by image processing, a method of classifying a direction of the line of sight by an output obtained by inputting image data to a classification model generated by supervised machine learning, and the like.

The emotion and line-of-sight analysis unit 212 analyzes transition of a blink status of the subject by referring to the image data. Examples of a method of analyzing a blink include, but are not limited to, a method of detecting a person’s face from an image to detect opening and closing of an eye.

The reliability calculation unit 213 calculates the reliability of the answer by the subject of the engagement survey by using at least one of an operation history of the subject with respect to the terminal 10A or image data obtained by imaging of the subject who is creating the answer. The reliability calculation unit 213 calculates the reliability for each question by using the answer time for each question calculated by the answer time and cursor data analysis unit 211, for example. In this case, in other words, it can also be said that the reliability is calculated for each question by use of the answer time for each question included in the engagement survey, the answer time being calculated by referring to the operation history.

The reliability calculation unit 213 may calculate the reliability for each question, based on the emotion of the subject analyzed by the emotion and line-of-sight analysis unit 212, for example. In this case, in other words, it can also be said that the reliability is information calculated for each question, based on the emotion of the subject analyzed by referring to the image data. The reliability calculation unit 213 may calculate the reliability for each question, based on analysis results of the emotion, line of sight, and blink of the subject analyzed by the emotion and line-of-sight analysis unit 212, for example.

More specifically, the reliability calculation unit 213 may calculate the reliability for each question so that the reliability is lower as the question having the shorter answer time, for example. The reliability calculation unit 213 may, for example, classify the emotion of the subject analyzed by the emotion and line-of-sight analysis unit 212 for each question, and calculate the reliability for each question so that the reliability is low in a case where a type of emotion of the subject contradicts the answer of the subject.

As another example, the reliability calculation unit 213 may calculate the reliability by using, for example, a machine learning model trained to output the reliability with the answer time for each question, the type of emotion of the subject, and the like as inputs. In this case, an input to the machine learning model includes, for example, at least one of an answer time for each question, a type of emotion of the subject, information indicating a direction of the line of sight, or information indicating a blink state. An output from the machine learning model includes, for example, information indicating the reliability. Training data used for training the machine learning model includes, for example, a plurality of pairs of information indicating the reliability and input data including at least one of an answer time for each question, a type of emotion of the subject, information indicating a direction of the line of sight, or information indicating a blink state. However, a method by which the reliability calculation unit 213 calculates the reliability is not limited to the above-described example, and the reliability calculation unit 213 may calculate the reliability by another method.

The reliability calculation unit 213 may calculate the reliability for each question included in the engagement survey, or may calculate one reliability for a plurality of questions. The reliability calculation unit 213 may calculate the reliability of the answer every predetermined unit time instead of calculating the reliability for each question. The reliability calculation unit 213 may generate information indicating transition of the reliability of the answer in a period during which the subject is answering the engagement survey.

### Configuration of Issue Extraction Device

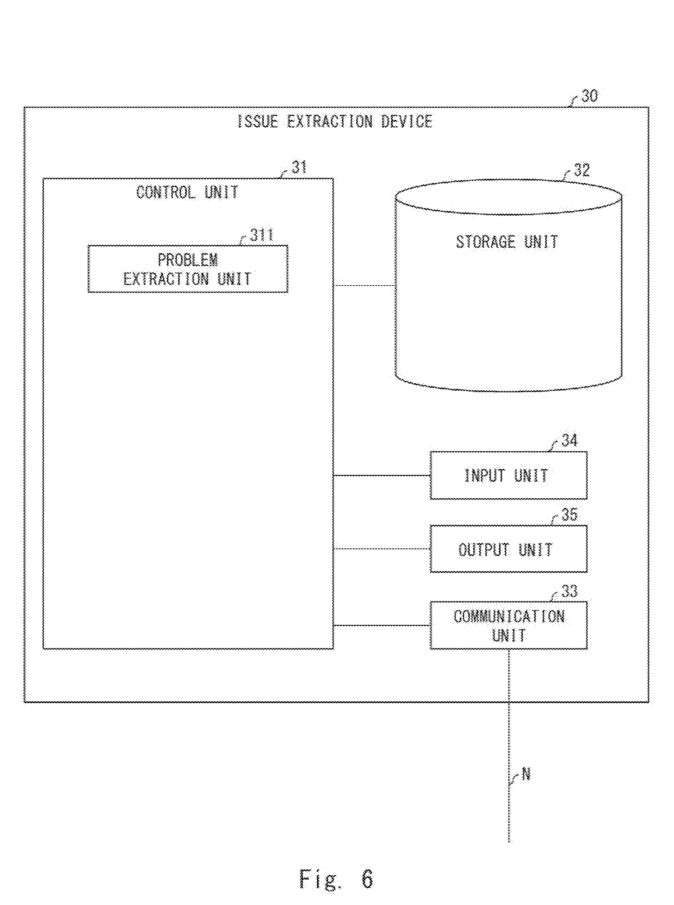

FIG. 6 is a block diagram illustrating a configuration of the issue extraction device 30. The issue extraction device 30 includes a control unit 31, a storage unit 32, a communication unit 33, an input unit 34, and an output unit 35. The control unit 31 executes commands of a computer program stored in the storage unit 32. The storage unit 32 stores the commands of the computer program executed by the control unit 31.

The communication unit 33 communicates with a device outside the issue extraction device 30 via the communication line N. The communication unit 33 transmits data supplied from the control unit 31 to another device, and supplies data received from another device to the control unit 31.

The input unit 34 is configured to receive an input to the issue extraction device 30, and includes, for example, an input device such as a keyboard, a mouse, a touch panel, a camera, or a microphone. The input unit 34 may be configured to receive data from the input device via, for example, an interface such as a USB.

The output unit 35 is configured to perform output from the issue extraction device 30, and includes, for example, an output device such as a display, a printer, a touch panel, or a speaker. The output unit 35 may have a configuration including an interface such as a USB, for example, and may be configured to output data to the output device via the interface.

The control unit 31 includes an issue extraction unit 311. The issue extraction unit 311 extracts an issue by referring to record data in which an interaction with the subject is recorded. More specifically, the issue extraction unit 311 extracts the issue by using voice data of the interaction, a text obtained from the voice data, and image data obtained by imaging of the subject during the interaction, for example. Still more specifically the issue extraction unit 311 may, for example, analyze an emotion of the subject by using at least one of the voice data, the text, or the image data, and extract the issue, based on utterance content of the subject in a time period in which the emotion is negative.

### Configuration of Feature Value Extraction Device

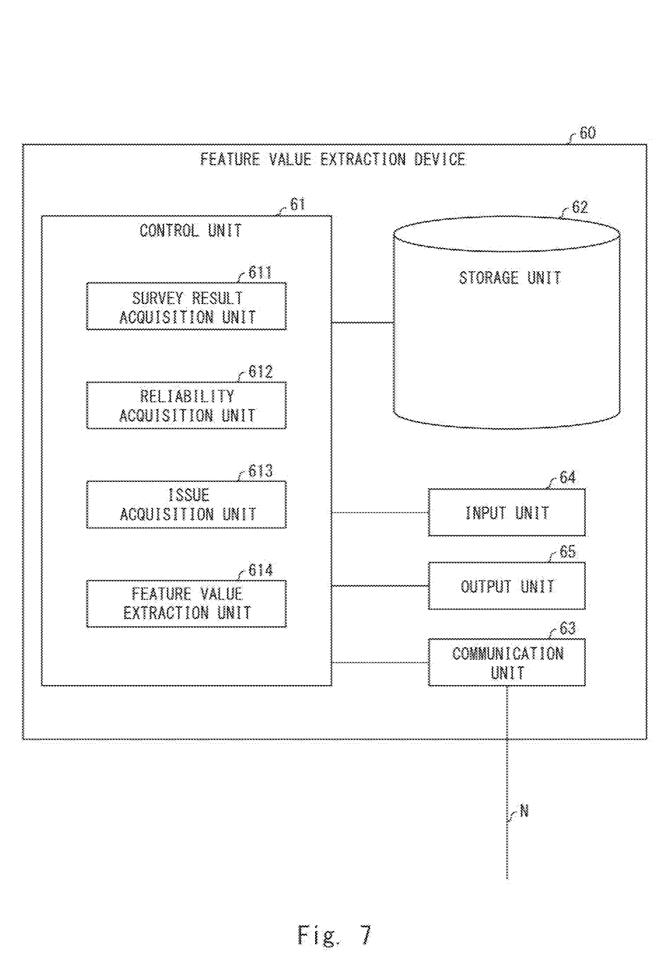

A configuration of the feature value extraction device 60 will be described with reference to FIG. 7. FIG. 7 is a block diagram illustrating the configuration of the feature value extraction device 60. The feature value extraction device 60 includes a control unit 61, a storage unit 62, a communication unit 63, an input unit 64, and an output unit 65. The control unit 61 executes commands of a computer program stored in the storage unit 62. The storage unit 62 stores the commands of the computer program executed by the control unit 61.

The communication unit 63 communicates with a device outside the feature value extraction device 60 via the communication line N. The communication unit 63 transmits data supplied from the control unit 61 to another device, and supplies data received from another device to the control unit 61.

The input unit 64 is configured to receive an input to the feature value extraction device 60, and includes, for example, an input device such as a keyboard, a mouse, a touch panel, a camera, or a microphone. The input unit 64 may be configured to receive data from the input device via, for example, an interface such as a USB.

The output unit 65 is configured to perform output from the feature value extraction device 60, and includes, for example, an output device such as a display, a printer, a touch panel, or a speaker. The output unit 65 may have a configuration including an interface such as a USB, for example, and may be configured to output data to the output device via the interface.

The control unit 61 includes a survey result acquisition unit 611, a reliability acquisition unit 612, an issue acquisition unit 613, and a feature value extraction unit 614. The survey result acquisition unit 611, the reliability acquisition unit 612, and the issue acquisition unit 613 are examples of a result acquisition means, a reliability acquisition means, and an issue acquisition means according to the present disclosure, respectively.

The survey result acquisition unit 611 acquires a result of the engagement survey for the subject from the common data base 40. The reliability acquisition unit 612 acquires reliability of an answer to the engagement survey from the common data base 40. The issue acquisition unit 613 acquires an issue obtained by the interaction with the subject from the common data base 40.

The feature value extraction unit 614 extracts a feature value of the survey result acquired by the survey result acquisition unit 611, the reliability acquired by the reliability acquisition unit 612, and the issue acquired by the issue acquisition unit 613. Here, for example, the feature value is represented by a vector in a predetermined feature value space of the survey result, the reliability, and the issue. However, the feature value is not limited to the example described above.

### Configuration of Engagement Analysis Server

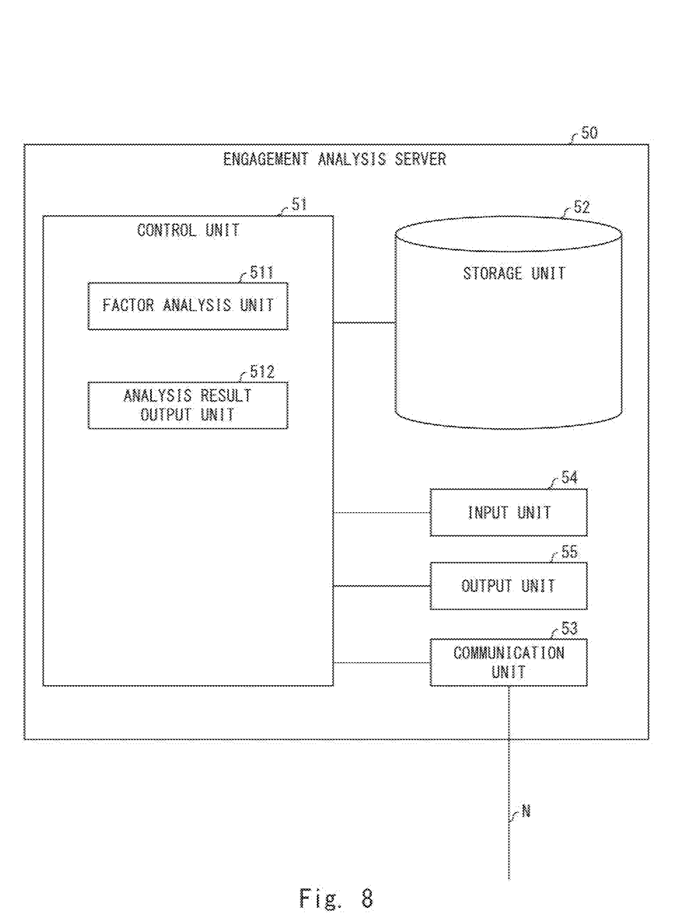

A configuration of the engagement analysis server 50 will be described with reference to FIG. 8. FIG. 8 is a block diagram illustrating the configuration of the engagement analysis server 50. The engagement analysis server 50 includes a control unit 51, a storage unit 52, a communication unit 53, an input unit 54, and an output unit 55. The control unit 51 executes commands of a computer program stored in the storage unit 52. The storage unit 52 stores the commands of the computer program executed by the control unit 51.

The communication unit 53 communicates with a device outside the engagement analysis server 50 via the communication line N. The communication unit 53 transmits data supplied from the control unit 51 to another device, and supplies data received from another device to the control unit 51.

The input unit 54 is configured to receive an input to the engagement analysis server 50, and includes, for example, an input device such as a keyboard, a mouse, a touch panel, a camera, or a microphone. The input unit 54 may be configured to receive data from the input device via, for example, an interface such as a USB.

The output unit 55 is configured to perform output from the engagement analysis server 50, and includes, for example, an output device such as a display, a printer, a touch panel, or a speaker. The output unit 55 may have a configuration including an interface such as a USB, for example, and may be configured to output data to the output device via the interface.

The control unit 51 includes a factor analysis unit 511 and an analysis result output unit 512. The analysis result output unit 512 is an example of an output means according to the present disclosure. The factor analysis unit 511 is an example of a factor analysis means and a measure generation means according to the present disclosure.

The factor analysis unit 511 analyzes a factor of improvement or decrease in engagement of the subject by using the feature value extracted by the feature value extraction device 60. Since the feature value extraction device 60 extracts the feature value from the survey result, the reliability, and the issue acquired from the common data base 40, it can also be said that the factor analysis unit 511 analyzes the factor by referring to the survey result, the reliability, and the issue stored in the common data base 40. The factor analysis unit 511 transmits, for example, the feature value extracted by the feature value extraction device 60 and a prompt for giving an instruction to analyze a factor to the generation model server 70, and acquires an answer obtained by input of the feature value and the prompt to the generation model as a factor analysis result.

The factor analysis unit 511 may generate a measure for improving engagement by referring to an analysis result of the factor of improvement or decrease in engagement. More specifically, the factor analysis unit 511 transmits, for example, a prompt for giving an instruction to generate a measure to the generation model server 70, and acquires a measure obtained by input of the prompt to the generation model. The prompt input to the generation model may include the feature value extracted by the feature value extraction device 60. The prompt may include at least one of the survey result, the reliability, or the issue acquired by the feature value extraction device 60.

The factor analysis unit 511 may calculate an engagement score of the subject by referring to the answer and reliability of the engagement survey. In a case where the reliability calculation device 20 generates information indicating the transition of the reliability, the factor analysis unit 511 may specify a timing at which the engagement of the subject is improved or decreased during the answer to the engagement survey, by using the result of the engagement survey and the information indicating the transition of the reliability, and analyze the factor by referring to the specified timing.

The analysis result output unit 512 outputs the analysis result by the factor analysis unit 511. The analysis result output unit 512 outputs the analysis result by transmitting data indicating the analysis result to the terminal 10 via the communication unit 53, for example. In this case, the terminal 10 displays, for example, the analysis result indicated by the received data on a display or the like.

The analysis result output unit 512 may output the analysis result by writing the data indicating the analysis result to a storage destination (the storage destination may be a storage device in the engagement analysis server 50 or a storage device outside the engagement analysis server 50) designated by a user of the engagement analysis server 50. The analysis result output unit 512 may output the data indicating the analysis result to an output device such as a display via the output unit 55.

The analysis result output unit 512 may output the measure generated by the factor analysis unit 511 in addition to the analysis result. The analysis result output unit 512 may output the engagement score in addition to the analysis result.

### Flow of Data Collection Method

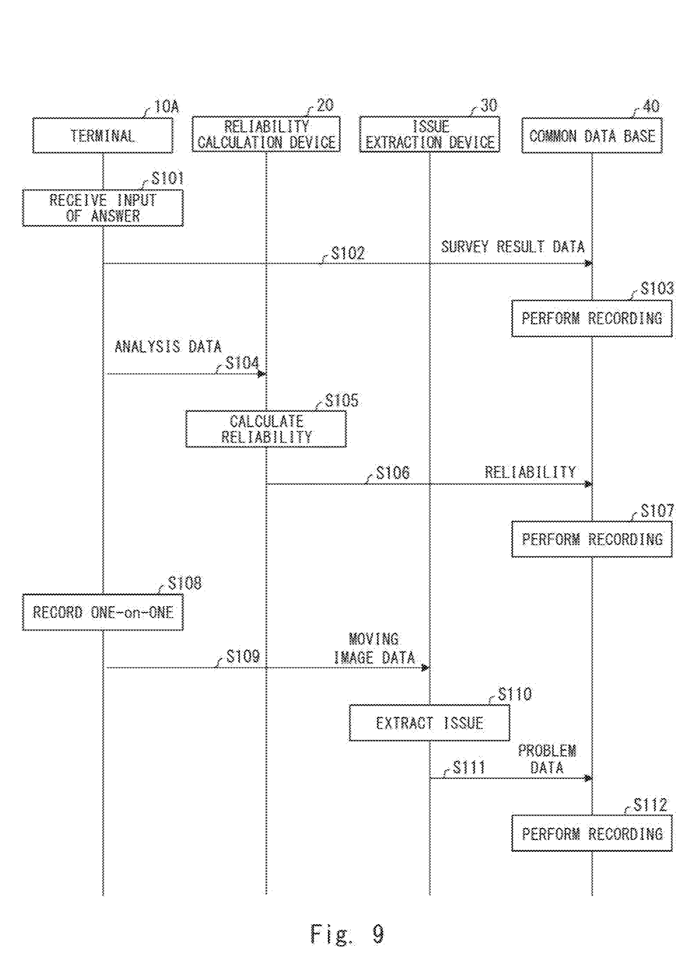

A description will be given of a flow of a method in which the information processing system 1A collects data in the common data base 40 and a flow of a method in which the information processing system 1A analyzes engagement with reference to the drawings. FIG. 9 is a diagram illustrating an example of the flow of the method in which the information processing system 1A collects data in the common data base 40. Note that steps illustrated in FIG. 9 may be executed in parallel or in a different order.

In steps S101 to S103, data regarding the engagement survey is collected. First, in step S101, the terminal 10A receives an input of an answer to the engagement survey. More specifically, the terminal 10A presents content of the engagement survey including a plurality of questions to the subject by, for example, displaying the content on the display. The subject inputs the answer to the engagement survey by using the terminal 10A. The subject sequentially answers the plurality of questions respectively by using the input unit 140 of the terminal 10A. Imaging of the subject is performed by a camera of the input unit 140 over a period during which the subject answers the engagement survey.

In step S102, the terminal 10A transmits survey result data indicating a result of the engagement survey to the common data base 40. The survey result data includes, for example, data indicating answers of the subject for respective questions included in the engagement survey. In step S103, the common data base 40 stores the survey result data received from the terminal 10A in a storage device.

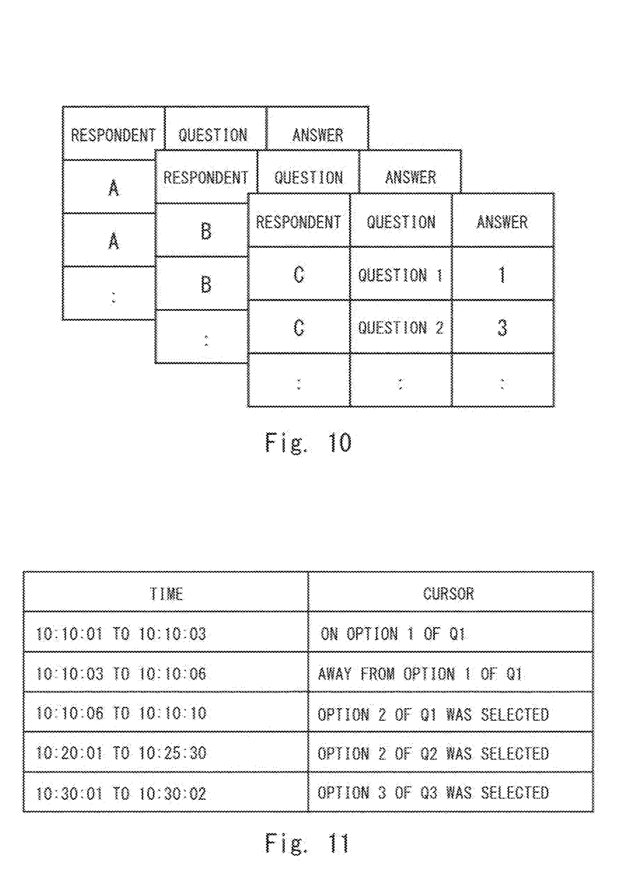

FIG. 10 is a diagram illustrating an example of the survey result data. In the example of FIG. 10, the survey result data includes items of “respondent”, “question”, and “answer”. The item of “respondent” stores identification information for identifying the subject of the engagement survey who is a respondent. The item of “question” stores identification information for identifying the question included in the engagement survey. The item of “answer” stores identification information for identifying the answer of the subject.

The description returns to FIG. 9. In step S104, the terminal 10A transmits analysis data for analyzing the reliability of the engagement survey result to the reliability calculation device 20. The analysis data includes, for example, answer time and cursor data, and image data. The answer time and cursor data is data indicating an operation history of the terminal 10A by the subject who is creating an answer to the engagement survey. The image data is data imaged by the camera or the like of the terminal 10A during performing the engagement survey. The image data may be still image data or may be moving image data.

FIG. 11 is a diagram illustrating an example of the answer time and cursor data. In the example of FIG. 11, the answer time and cursor data includes items of “time” and “cursor”. The item of “cursor” stores cursor data indicating which one of the questions included in the engagement survey and the options included in each question the cursor was on or away from. The item of “time” stores information indicating a time period relevant to the information in the item of “cursor”.

The description returns to FIG. 9. In step S105, the reliability calculation device 20 calculates the reliability by using the analysis data. The reliability calculation processing performed by the reliability calculation device 20 will be described later by changing the reference drawing. In step S106, the reliability calculation device 20 transmits the calculated reliability to the common data base 40. In step S107, the common data base 40 stores the received reliability in the storage device.

In steps S108 to S112, data of a one-on-one meeting is collected. In step S108, a one-on-one meeting between the subject and the group leader is performed, and the camera of the terminal 10A images and records a state of the meeting over a period during which the meeting is performed, and a microphone of the terminal 10A records voices of the meeting. The terminal 10A to which the subject inputs the answer to the engagement survey and the terminal 10A that records the state of the one-on-one meeting may be the same terminal or different terminals.

In step S109, the terminal 10A transmits moving image data in which the one-on-one meeting is recorded to the issue extraction device 30. In step S110, the issue extraction device 30 extracts an issue by using the moving image data. Details of processing for extracting an issue by the issue extraction device 30 will be described later. In step S111, the issue extraction device 30 transmits issue data indicating the extracted issue to the common data base 40. In step S112, the common data base 40 stores the issue data received from the issue extraction device 30 in the storage device.

### Specific Example of Reliability Calculation Processing

FIG. 12 is a flow diagram illustrating an example of a flow of reliability calculation processing (processing in step S105 in FIG. 9) performed by the reliability calculation device 20. Note that steps illustrated in FIG. 12 may be executed in parallel or in a different order. In step S201, the answer time and cursor data analysis unit 211 of the reliability calculation device 20 analyzes the answer time and cursor data for each question included in the engagement survey by referring to the operation history of the terminal 10A by the subject who is creating an answer to the engagement survey.

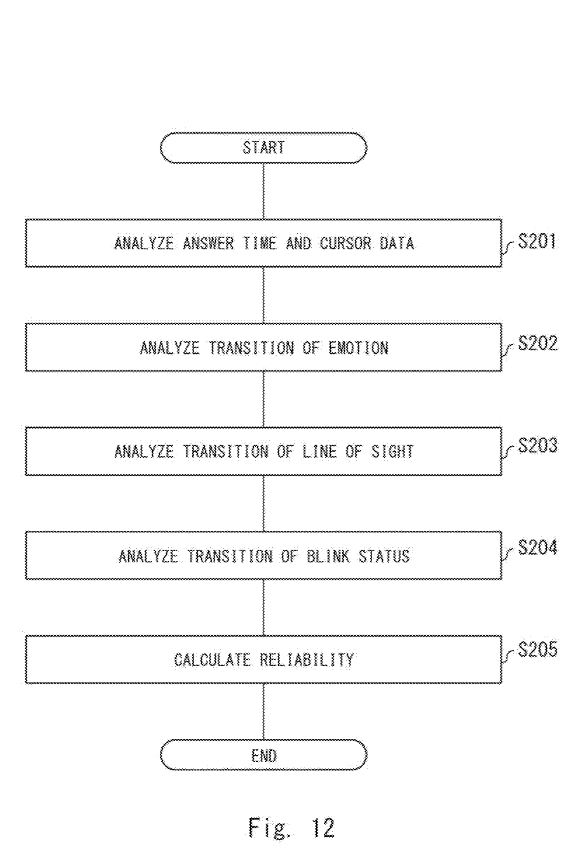

FIG. 13 is a diagram illustrating an example of an analysis result by the answer time and cursor data analysis unit 211. In the example of FIG. 13, the answer time and cursor data analysis unit 211 generates answer time and cursor analysis data D12 by using answer time and cursor data D11. In the example of FIG. 13, the answer time and cursor analysis data D12 includes items of “time”, “question”, and “cursor”. The item of “question” stores information for identifying the question. The item of “time” stores information indicating a time period in which the question is answered. The item of “cursor” stores information representing a cursor operation status of the subject obtained by analysis of the cursor data.

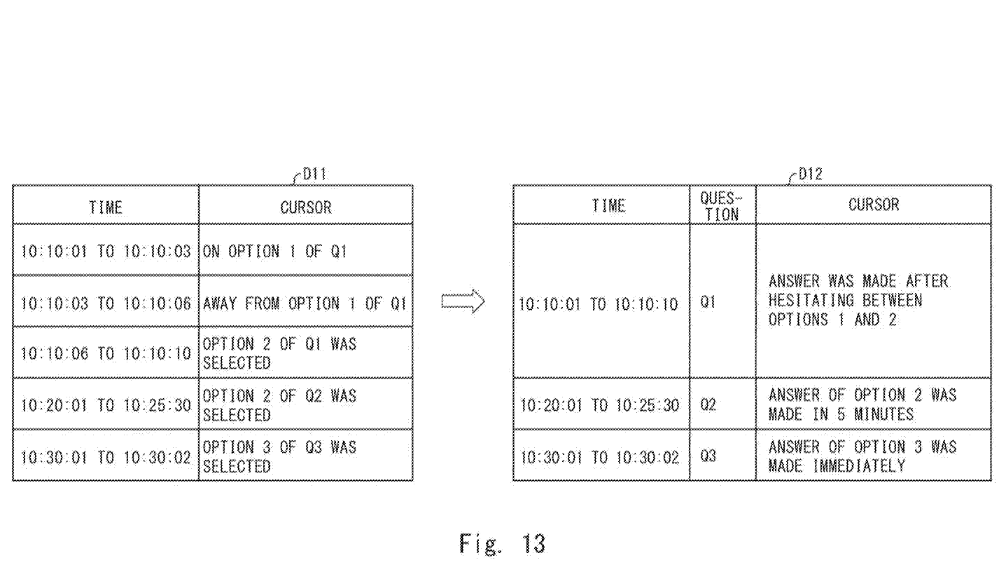

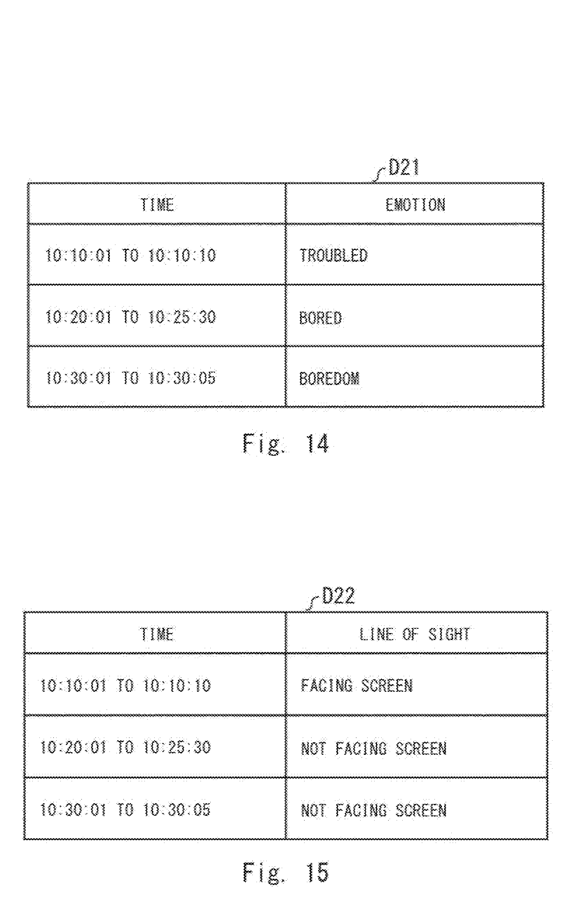

The description returns to FIG. 12. In step S202, the emotion and line-of-sight analysis unit 212 analyzes the transition of the emotion of the subject by referring to the image data. FIG. 14 is a diagram illustrating an example of an analysis result of an emotion by the emotion and line-of-sight analysis unit 212. In the example of FIG. 14, the emotion and line-of-sight analysis unit 212 generates emotion analysis data D21 by referring to the image data. In the example of FIG. 14, the emotion analysis data D21 includes items of “time” and “emotion”. The item of “emotion” stores information indicating a type of emotion obtained by the analysis, such as “troubled”, “bored”, and “boredom”. The item of “time” stores information indicating a time period relevant to the type of emotion obtained by the analysis.

The description returns to FIG. 12. In step S203, the emotion and line-of-sight analysis unit 212 analyzes the transition of the line of sight of the subject by referring to the image data. FIG. 15 is a diagram illustrating an example of an analysis result of a line of sight by the emotion and line-of-sight analysis unit 212. In the example of FIG. 15, the emotion and line-of-sight analysis unit 212 generates line-of-sight analysis data D22 by referring to the image data. In the example of FIG. 15, the line-of-sight analysis data D22 includes items of “time” and “line of sight”. The item of “line of sight” stores information indicating a direction of the line of sight obtained by the analysis, such as “facing the screen” and “not facing the screen”. The item of “time” stores information indicating a time period relevant to the direction of the line of sight obtained by the analysis.

The description returns to FIG. 12. In step S204, the emotion and line-of-sight analysis unit 212 analyzes the transition of the blink status of the subject by referring to the image data. FIG. 16 is a diagram illustrating an example of an analysis result of a blink by the emotion and line-of-sight analysis unit 212. In the example of FIG. 16, the emotion and line-of-sight analysis unit 212 generates blink analysis data D23 by referring to the image data. In the example of FIG. 16, the blink analysis data D23 includes items of “time” and “blink”. The item of “blink” stores information representing a blink state obtained by the analysis, such as “normal” and “no blink”. The item of “time” stores information indicating a time period relevant to the analysis result of the blink.

The description returns to FIG. 12. In step S205, the reliability calculation unit 213 calculates the reliability by using the analysis result of the emotion, the analysis result of the line of sight, and the analysis result of the blink by the emotion and line-of-sight analysis unit 212. The reliability calculation unit 213 may, for example, classify the analysis result of the emotion by the emotion and line-of-sight analysis unit 212 for each question, and calculate the reliability for each question so that the reliability is low in a case where the type of emotion of the subject contradicts the answer of the subject. The reliability calculation unit 213 may, for example, refer to the analysis result of the line of sight by the emotion and line-of-sight analysis unit 212, and calculate the reliability for each question so that the reliability is low in a case where the line of sight of the subject does not face the screen. The reliability calculation unit 213 may, for example, refer to the analysis result of the blink by the emotion and line-of-sight analysis unit 212, and calculate the reliability for each question so that the reliability is lower as the number of a blink is smaller.

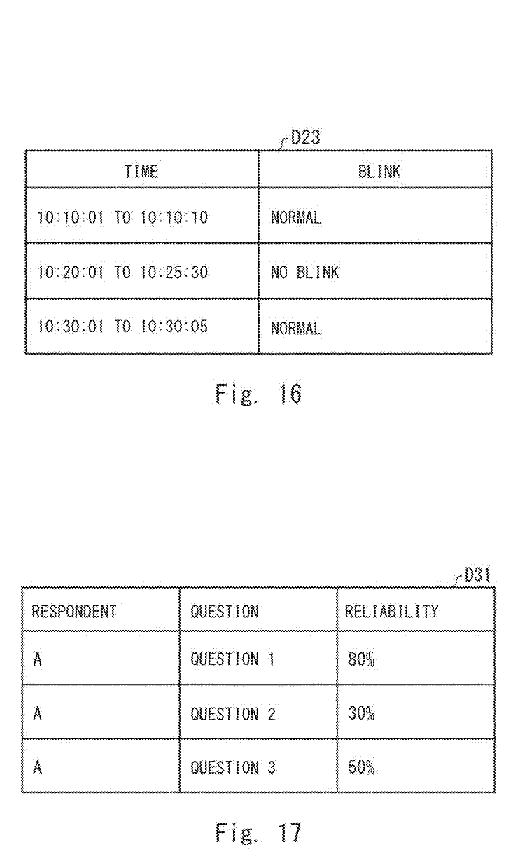

FIG. 17 is a diagram illustrating an example of the reliability calculated by the reliability calculation unit 213. In the example of FIG. 17, the reliability calculation unit 213 generates the reliability data D31 by using the analysis result of the emotion, the analysis result of the line of sight, and the analysis result of the blink by the emotion and line-of-sight analysis unit 212. In the example of FIG. 17, the reliability data D31 includes items of “respondent”, “ question”, and “reliability”. The item of “respondent” stores identification information for identifying the subject of the engagement survey. The item of “question” stores identification information for identifying the question included in the engagement survey. The item of “reliability” stores information indicating the reliability of the answer of the subject to each question. It can also be said that the reliability for each question illustrated in FIG. 17 is information indicating the transition of the reliability of the answer in the period during which the answer is being made to the engagement survey.

In the example of FIG. 17, the reliability calculation unit 213 calculates the reliability for each question, but the method by which the reliability calculation unit 213 calculates the reliability is not limited to the example of FIG. 17. The reliability calculation unit 213 may calculate the reliability of the answer for each unit time in the period during which the answer is being made to the engagement survey, for example. Also in this case, it can also be said that the reliability for each unit time is information indicating the transition of the reliability of the answer in the period during which the answer is being made to the engagement survey.

### Specific Example of Issue Extraction Processing

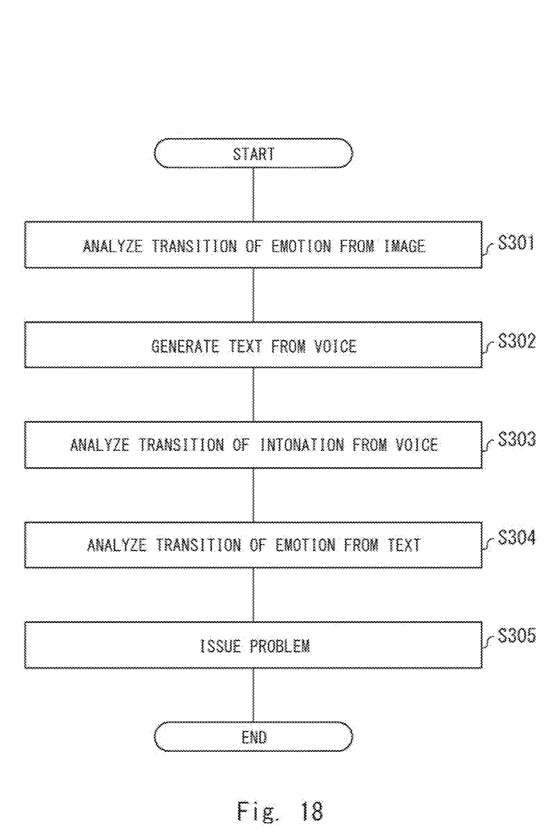

FIG. 18 is a flow diagram illustrating an example of a flow of issue extraction processing (processing in step S110 in FIG. 9) performed by the issue extraction device 30. Note that steps illustrated in FIG. 18 may be executed in parallel or in a different order. In step S301, the issue extraction unit 311 of the issue extraction device 30 analyzes the transition of the emotion of the subject from the image by referring to the image data. Examples of a method of analyzing an emotion include, but are not limited to, a method of analyzing a shape and movement of a face by using a feature point of the face detected from an image and texture information on the image, a method of classifying an emotion by an output obtained by inputting image data into a classification model generated by supervised machine learning, and the like.

FIG. 19 is a diagram illustrating an example of the analysis result of the emotion by the issue extraction unit 311. In the example of FIG. 19, the issue extraction unit 311 generates emotion analysis data D51 by referring to the image data. In the example of FIG. 19, the emotion analysis data D51 includes items of “name”, “time”, and “emotion”. The item of “name” stores identification information for identifying the subject. The item of “emotion” stores information indicating the type of emotion obtained by the analysis, such as “sadness” and “fatigue”. The item of “time” stores information indicating a time period relevant to the type of emotion obtained by the analysis.

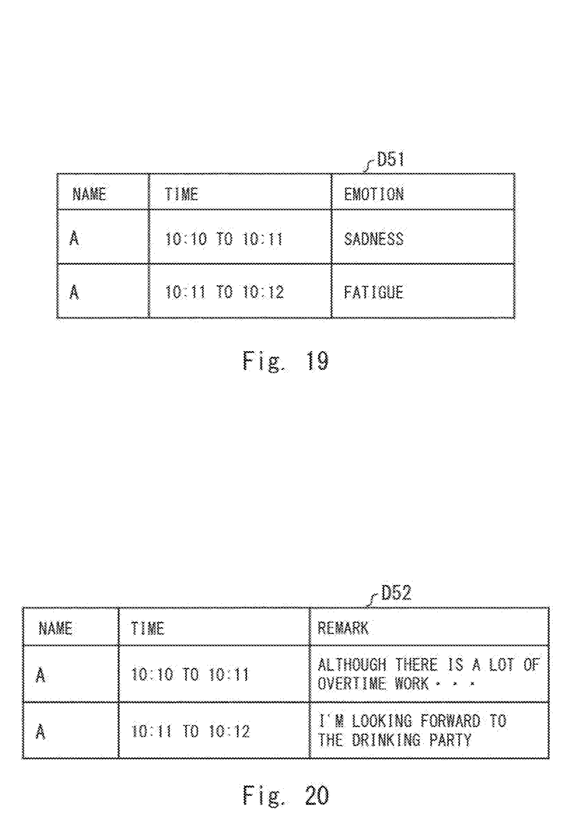

The description returns to FIG. 18. In step S302, the issue extraction unit 311 generates a text representing remark content of the subject from the voice data. FIG. 20 is a diagram illustrating an example of a text generated by the issue extraction unit 311. In the example of FIG. 20, the issue extraction unit 311 generates transcription data D52 from the voice data. In the example of FIG. 20, the transcription data D52 includes items of “name”, “time”, and “remark”. The item of “name” stores identification information for identifying the subject. The item of “remark” stores texts such as “although there is a lot of overtime work ···” and “I’m looking forward to the drinking party”. The item of “time” stores information indicating a time period relevant to the text.

In step S303 of FIG. 18, the issue extraction unit 311 analyzes transition of intonation of the subject from the voice by referring to the voice data. It can also be said that the intonation of the voice is an example of information representing the emotion of the subject. Examples of a method of analyzing intonation include, but are not limited to, a method of specifying a type of intonation, based on an output obtained by inputting voice data to a classification model generated by supervised machine learning.

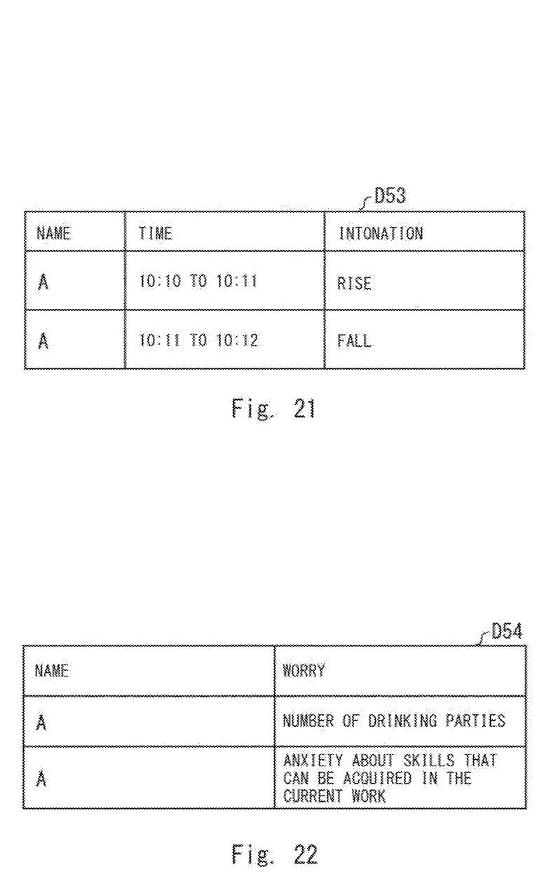

FIG. 21 is a diagram illustrating an example of an analysis result of intonation by the issue extraction unit 311. In the example of FIG. 21, the issue extraction unit 311 generates intonation analysis data D53 by referring to the voice data. In the example of FIG. 21, the intonation analysis data D53 includes items of “name”, “time”, and “intonation”. The item of “name” stores identification information for identifying the subject. The item of “intonation” stores information indicating the type of intonation obtained by the analysis, such as “rise” and “fall”. The item of “time” stores information indicating a time period relevant to the type of intonation obtained by the analysis.

In step S304 of FIG. 18, the issue extraction unit 311 analyzes the transition of the emotion of the subject from the text that has been transcribed. Examples of a method of analyzing an emotion from text include, but are not limited to, a method of specifying a type of emotion, based on an output obtained by inputting text into a classification model generated by supervised machine learning.

In step S305, the issue extraction unit 311 extracts an issue of the subject by using at least one of the analysis result of the emotion by use of the image, the analysis result of the emotion by use of the voice (intonation, or the like), or the analysis result of the emotion by use of the text. The issue extraction unit 311 specifies a time period in which the emotion of the subject is negative by using the analysis result of the emotion by use of the image, then analysis result of the emotion by use of the voice (intonation, or the like), and the analysis result of the emotion by use of the text, and extracts the issue from the remark content of the subject in the specified time period, for example. Examples of the time period in which the emotion of the subject is negative include, but are not limited to, a time period in which at least one of the analysis result of the emotion by use of the image, the analysis result of the emotion by use of the voice, or the analysis result of the emotion by use of the text indicates a negative emotion. Examples of a method of extracting an issue from the remark content of the subject include, but are not limited to, a method of extracting an issue, based on an output (text showing summary results, or the like) obtained by inputting a prompt for giving an instruction to summarize the text representing the remark content of the subject to the generation model.

FIG. 22 is a diagram illustrating an example of the issue extracted by the issue extraction unit 311. In the example of FIG. 22, the issue extraction unit 311 generates issue data D54. In the example of FIG. 22, the issue data D54 includes items of “name” and “worry”. The item of “name” stores identification information for identifying the subject. The item of “worry” stores a text indicating a worry (issue) of the subject, such as “a number of drinking parties”, “anxiety about skills that can be acquired in the current work”, or the like.

### Flow of Factor Analysis Method

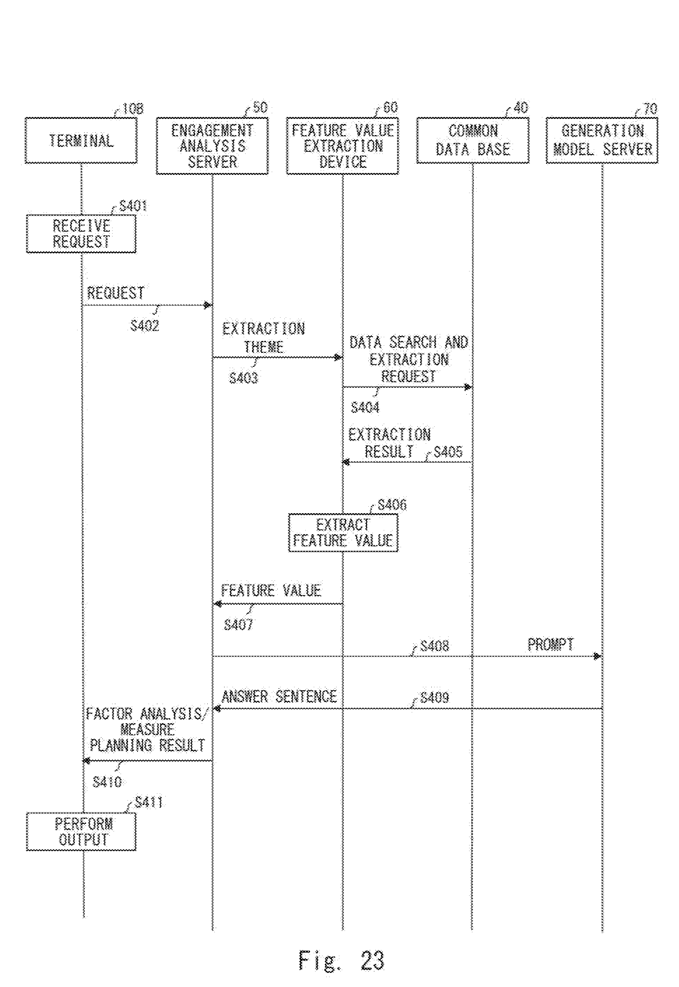

FIG. 23 is a diagram illustrating an example of a flow of a factor analysis method of the information processing system 1A. Note that steps illustrated in FIG. 23 may be executed in parallel or in a different order. In step S401, a client inputs a request for factor analysis and measure planning by using an operation unit of the terminal 10B, and the terminal 10B receives the request for factor analysis and measure planning from the client. In step S402, the terminal 10B transmits the request for analysis of a factor and measure planning to the engagement analysis server 50.

In step S403, the engagement analysis server 50 transmits an extraction theme to the feature value extraction device 60, based on the request received from the terminal 10B. The extraction theme indicates an extraction condition from which question or answer the feature value is extracted. Examples of the feature value extraction theme include, but are not limited to, “a feature value of a factor for which the answer of question 4 is 1”, “a feature value of a factor for which the answer of question 4 is 5”, and “a feature value of a factor for which the answer of question 4 has changed from 1 to 5”.

In step S404, the feature value extraction device 60 transmits a request indicating a data search and extraction request to the common data base 40. The request includes an extraction condition for extracting data, for example. In step S405, the common data base 40 transmits data extracted according to the extraction condition to the feature value extraction device 60 as an extraction result, based on the request received from the feature value extraction device 60.

In step S406, the feature value extraction device 60 extracts a feature value from the data extracted in the common data base 40. In step S407, the feature value extraction device 60 transmits the extracted feature value to the engagement analysis server 50.

In step S408, the engagement analysis server 50 transmits a prompt for giving an instruction to analyze a factor to the generation model server 70. In step S409, the generation model server 70 transmits an answer sentence obtained by inputting the prompt to the generation model to the engagement analysis server 50. In step S410, the engagement analysis server 50 transmits a factor analysis result and a measure planning result to the terminal 10B. In step S411, the terminal 10B outputs the received factor analysis result and measure planning result by, for example, displaying them on a display device.

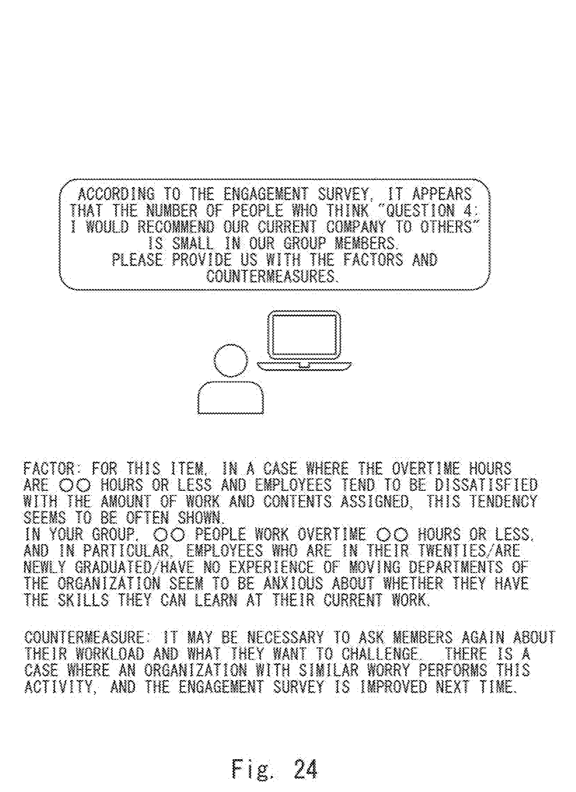

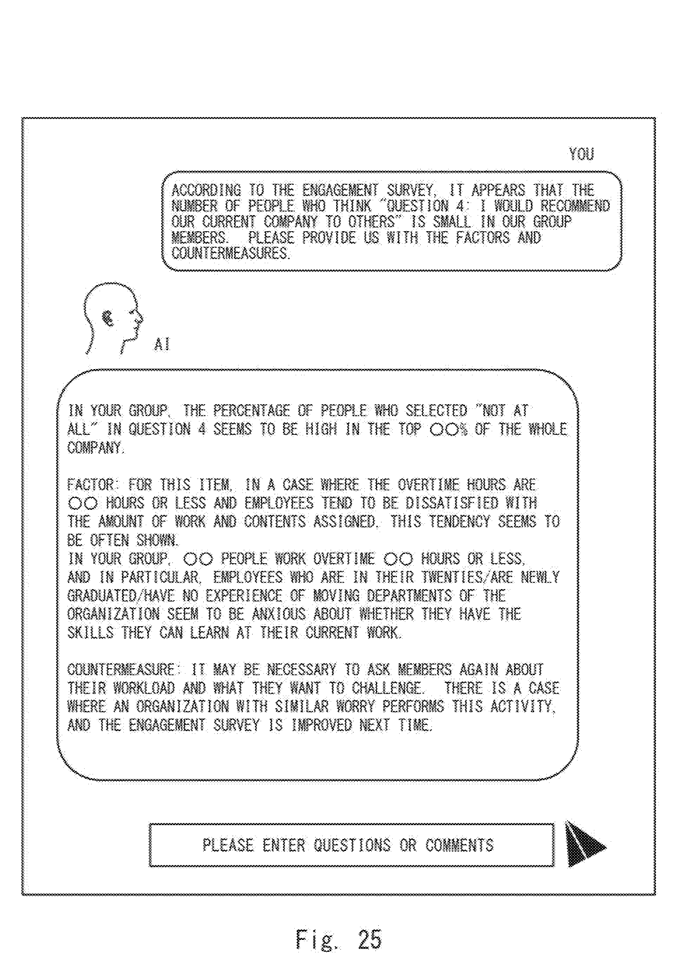

FIGS. 24 and 25 are diagrams illustrating an example of the factor analysis request input to the terminal 10B by the client and the factor analysis result and measure planning result output by the terminal 10B.

### Effects of Information Processing System

As described above, in the information processing system 1A, a configuration is adopted in which the factor analysis unit 511 generates a measure for improving the engagement by referring to the analysis result, and the analysis result output unit 512 outputs the measure in addition to the analysis result. According to the information processing system 1A, it is therefore possible to obtain an effect that the user can grasp a measure for improving engagement.

In the information processing system 1A, a configuration is adopted in which the subject operates the terminal 10A to create an answer to the engagement survey, and the reliability acquisition unit 612 acquires the reliability calculated by the reliability calculation unit 213 using the operation history of the subject with respect to the terminal 10A and the image data obtained by imaging of the subject who is creating the answer. According to the information processing system 1A, the reliability calculated with higher accuracy can therefore be used, so that the user can more appropriately grasp a factor of improvement or decrease in engagement.

In the information processing system 1A, a configuration is adopted in which the reliability is information calculated for each question by use of an answer time for each question included in the engagement survey, the answer time being calculated by referring to the operation history. According to the information processing system 1A, it is therefore possible to more appropriately grasp the factor of improvement or decrease in engagement by using the reliability calculated by use of the answer time for each question included in the engagement survey.

In the information processing system 1A, a configuration is adopted in which the reliability is information calculated for each question, based on an emotion of the subject for each question included in the engagement survey, the emotion being analyzed by referring to the image data. According to the information processing system 1A, it is therefore possible to more appropriately grasp the factor of improvement or decrease in engagement by using the reliability calculated in consideration of the emotion of the subject obtained by the analysis.

In the information processing system 1A, a configuration is adopted in which the issue acquisition unit 613 acquires an issue extracted by using the voice data of the interaction, the text obtained from the voice data, and the image data obtained by imaging of the subject during the interaction. According to the information processing system 1A, it is therefore possible to more accurately analyze the factor of improvement or decrease in engagement of the subject by using the issue extracted by use of the voice of the interaction with the subject, the text obtained from the voice, and the imaged data.

In the information processing system 1A, a configuration is adopted in which the issue acquisition unit 613 acquires the issue extracted based on utterance content of the subject in a time period in which an emotion of the subject is negative, the emotion being analyzed by use of at least one of the voice data, the text, or the image data. According to the information processing system 1A, it is therefore possible to more accurately analyze the factor of improvement or decrease in engagement of the subject by using the issue extracted in consideration of the emotion of the subject obtained by the analysis.

In the information processing system 1A, a configuration is adopted in which the reliability acquisition unit 612 acquires information indicating the transition of the reliability of the answer in the period during which the subject is answering the engagement survey, and the factor analysis unit 511 specifies the timing at which the engagement of the subject is improved or decreased during the answer to the engagement survey by using the result of the engagement survey and the information indicating the transition of the reliability, and analyzes the factor by referring to the specified timing. According to the information processing system 1A, it is therefore possible to obtain an effect of being able to more accurately analyze the factor of improvement or decrease in engagement of the subject by considering the transition of the reliability in the period during which the answer is being made.

### IMPLEMENTATION EXAMPLE BY SOFTWARE

Some or all of the functions of the information processing device 1, the terminal 10A, the terminal 10B, the reliability calculation device 20, the issue extraction device 30, the common data base 40, the engagement analysis server 50, the feature value extraction device 60, and the generation model server 70 (hereinafter, also referred to as “each of the above devices”) may be implemented by hardware such as an integrated circuit (IC chip) or may be implemented by software.

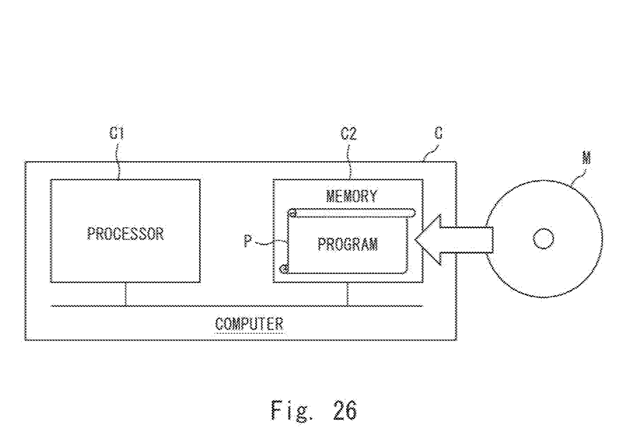

In the latter case, each of the above devices is implemented by, for example, a computer that executes commands of a program that is software for implementing each function. An example of such a computer (which will be referred to as a computer C hereinafter) is illustrated in FIG. 26. FIG. 26 is a block diagram illustrating a hardware configuration of the computer C that functions as each of the above devices.

The computer C includes at least one processor C1 and at least one memory C2. A program P for causing the computer C to operate as each of the above devices is recorded in the memory C2. In the computer C, by the processor C1 reading the program P from the memory C2 and executing the program P, each function of each of the above devices is implemented.

As the processor C1, for example, a Central Processing Unit (CPU), a Graphic Processing Unit (GPU), a Digital Signal Processor (DSP), a Micro Processing Unit (MPU), a Floating point number Processing Unit (FPU), a Physics Processing Unit (PPU), a Tensor Processing Unit (TPU), a quantum processor, a microcontroller, or a combination of these can be used. As the memory C2, for example, a flash memory, a Hard Disk Drive (HDD), a Solid State Drive (SSD), or a combination of these can be used.

The computer C may further include a Random Access Memory (RAM) for loading the program P at the time of execution and temporarily storing various types of data. The computer C may further include a communication interface for transmitting and receiving data to and from another device. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, a programmable logic circuit, or the like can be used. The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

Each of the above functions of each of the above devices may be implemented by a single processor provided in a single computer, may be implemented in cooperation with a plurality of processors provided in a single computer, or may be implemented in cooperation with a plurality of processors provided in a plurality of computers. The program for causing each of the above devices to implement each of the above functions may be stored in a single memory provided in a single computer, may be stored in a distributed manner in a plurality of memories provided in a single computer, or may be stored in a distributed manner in a plurality of memories provided in a plurality of computers.

### SUPPLEMENTARY INFORMATION A

The present disclosure includes the techniques described in the following supplementary notes. However, the present disclosure is not limited to the techniques described in the following supplementary notes, and various modifications can be made within the scope described in the claims.

### Supplementary note A1

An information processing method including

acquiring a result of an engagement survey;

acquiring a reliability of an answer by a subject of the engagement survey;

acquiring an issue based on text data obtained from the subject;

generating a factor analysis result for a factor affecting an engagement by using the result, the reliability, and the issue; and

outputting the factor analysis result.

### Supplementary note A2

The information processing method according to supplementary note A1, further including

generating a measure to improve the engagement by referring to the factor analysis result and

outputting the measure in addition to the factor analysis result.

### Supplementary note A3

The information processing method according to supplementary note A1 or B2, further including

acquiring the reliability based on an operation history of the subject with respect to the terminal and image data of the subject.

### Supplementary note A4

The information processing method according to supplementary note A3, in which the operation history includes an answer time for each question in the engagement survey, and

in which the method comprises calculating the reliability for each question based on the answer time.

### Supplementary note A5

The information processing method according to supplementary note A3 or A4, further including

detecting an emotion of the subject for each question based on the image data; and

calculating the reliability for each question based on the emotion .

### Supplementary note A6

The information processing method according to any one of supplementary notes A1 to A5, further including

extracting the issue based on voice data of an interaction with a subject, text data obtained from the voice data and image data of the subject captured during the interaction .

### Supplementary note A7

The information processing method according to supplementary note A6, further including

detecting an emotion of the subject by use of at least one of the voice data, the text data, or the image data; and

extracting the issue based on utterance content of the subject in a time period in which the detected emotion is negative.

### Supplementary note A8

The information processing method according to any one of supplementary notes A3 to A7, further including

acquiring information indicating a transition of reliability of an answer during a period in which the subject is answering the engagement survey;

detecting a timing indicating the engagement of the subject is improved or decreased, based on the result of the engagement survey and the acquired information; and

analyzing the factor based on the timing.

### SUPPLEMENTARY INFORMATION B

The present disclosure includes the techniques described in the following supplementary notes. However, the present disclosure is not limited to the techniques described in the following supplementary notes, and various modifications can be made within the scope described in the claims.

### Supplementary note B1

The information processing apparatus including at least one processor configured to execute the one or more instructions to:

acquire a result of an engagement survey;

acquire reliability of an answer by a subject of the engagement survey;

acquire an issue based on text data obtained from the subject;

generate a factor analysis result for a factor affecting an engagement by using the result, the reliability, and the issue; and

output the factor analysis result.

The information processing apparatus may further include a memory. The memory may store a program for causing the at least one processor to execute the pieces of processing.

### Supplementary note B2

The information processing apparatus according to supplementary note B1, in which

the at least one processor

further executes to generate a measure to improve the engagement based on the factor analysis result; and

output the measure in addition to the factor analysis result .

### Supplementary note B3

The information processing apparatus according to supplementary note B1 or B2, in which

the at least one processor is further configured to execute the one or more instructions to acquire the reliability based on an operation history of the subject with respect to the terminal and image data of the subject.

### Supplementary note B4

The information processing apparatus according to supplementary note B3, in which the operation history includes an answer time for each question in the engagement survey, and

in which the at least one processor is further configured to execute the one or more instructions to calculate the reliability for each question based on the answer time

### Supplementary note B5

The information processing apparatus according to supplementary note B3 or B4, in which the at least one processor is further configured to execute the one or more instructions to:

detect an emotion of the subject for each question based on the image data; and

calculate the reliability for each question based on the emotio .

### Supplementary note B6

The information processing apparatus according to any one of supplementary notes B1 to B5, in which the at least one processor is further configured to execute the one or more instructions to extract the issue based on voice data of an interaction with a subject, text data obtained from the voice data and image data of the subject captured during the interaction.

### Supplementary note B7

The information processing apparatus according to supplementary note B6, in which the at least one processor is further configured to execute the one or more instructions to:

detect an emotion of the subject by use of at least one of the voice data, the text data, or the image data; and

extract the issue based on utterance content of the subject in a time period in which the detected emotion is negative.

### Supplementary note B8

The information processing apparatus according to any one of supplementary notes B3 to B4, in which

the at least one processor is further configured to execute the one or more instructions to:

acquire information indicating a transition of reliability of an answer during a period in which the subject is answering the engagement survey;

detect a timing indicating the engagement of the subject is improved or decreased, based on the result of the engagement survey and the acquired information; and

analyze the factor based on the timing.

### SUPPLEMENTARY INFORMATION C

The present disclosure includes the techniques described in the following supplementary notes. However, the present disclosure is not limited to the techniques described in the following supplementary notes, and various modifications can be made within the scope described in the claims.

### Supplementary note C1

A non-transitory computer readable medium storing a program for causing a computer to

acquire a result of an engagement survey;

acquire a reliability of an answer by a subject of the engagement survey;

acquire an issue based on text data obtained from the subject;

generate a factor analysis result for a factor affecting an engagement by using the result, the reliability, and the issue; and

output the factor analysis result.

What is claimed is:

1. An information processing apparatus comprising:
at least one memory configured to store one or more instructions; and
at least one processor configured to execute the one or more instructions to:
acquire a result of an engagement survey;
acquire reliability of an answer by a subject of the engagement survey;
acquire an issue based on text data obtained from the subject;
generate a factor analysis result for a factor affecting an engagement by using the result, the reliability, and the issue; and
output the factor analysis result.

2. The information processing apparatus according to claim 1, wherein the at least one processor is further configured to execute the one or more instructions to:
generate a measure to improve the engagement based on the factor analysis result; and
output the measure in addition to the factor analysis result.

3. The information processing apparatus according to claim 1, wherein the at least one processor is further configured to execute the one or more instructions to acquire the reliability based on an operation history of the subject with respect to the terminal and image data of the subject.

4. The information processing apparatus according to claim 3, wherein the operation history includes an answer time for each question in the engagement survey, and
wherein the at least one processor is further configured to execute the one or more instructions to calculate the reliability for each question based on the answer time.

5. The information processing apparatus according to claim 3, wherein the at least one processor is further configured to execute the one or more instructions to:
detect an emotion of the subject for each question based on the image data; and
calculate the reliability for each question based on the emotion.

6. The information processing apparatus according to claim 1, wherein the at least one processor is further configured to execute the one or more instructions to extract the issue based on voice data of an interaction with a subject, text data obtained from the voice data and image data of the subject captured during the interaction.

7. The information processing apparatus according to claim 6, wherein the at least one processor is further configured to execute the one or more instructions to:
detect an emotion of the subject by use of at least one of the voice data, the text data, or the image data; and
extract the issue based on utterance content of the subject in a time period in which the detected emotion is negative.

8. The information processing apparatus according to claim 1, wherein the at least one processor is further configured to execute the one or more instructions to:
acquire information indicating a transition of reliability of an answer during a period in which the subject is answering the engagement survey;
detect a timing indicating the engagement of the subject is improved or decreased, based on the result of the engagement survey and the acquired information; and
analyze the factor based on the timing.

9. An information processing method comprising:
acquiring a result of an engagement survey;
acquiring a reliability of an answer by a subject of the engagement survey;
acquiring an issue based on text data obtained from the subject;
generating a factor analysis result for a factor affecting an engagement by using the result, the reliability, and the issue; and
outputting the factor analysis result.

10. The information processing method according to claim 9, further comprising:
generating a measure to improve the engagement by referring to the factor analysis result and
outputting the measure in addition to the factor analysis result.

11. The information processing method according to claim 9, further comprising:
acquiring the reliability based on an operation history of the subject with respect to the terminal and image data of the subject.

12. The information processing method according to claim 11, wherein the operation history includes an answer time for each question in the engagement survey, and
wherein the method comprises calculating the reliability for each question based on the answer time.

13. The information processing method according to claim 11, further comprising:
detecting an emotion of the subject for each question based on the image data; and
calculating the reliability for each question based on the emotion.

14. The information processing method according to claim 9, further comprising:
extracting the issue based on voice data of an interaction with a subject, text data obtained from the voice data and image data of the subject captured during the interaction.

15. The information processing method according to claim 14, further comprising:
detecting an emotion of the subject by use of at least one of the voice data, the text data, or the image data; and
extracting the issue based on utterance content of the subject in a time period in which the detected emotion is negative.

16. The information processing method according to claim 9, further comprising:
acquiring information indicating a transition of reliability of an answer during a period in which the subject is answering the engagement survey;
detecting a timing indicating the engagement of the subject is improved or decreased, based on the result of the engagement survey and the acquired information; and
analyzing the factor based on the timing.

17. A non-transitory storage medium storing a program causing a computer to:
acquire a result of an engagement survey;
acquire a reliability of an answer by a subject of the engagement survey;
acquire an issue based on text data obtained from the subject;
generate a factor analysis result for a factor affecting an engagement by using the result, the reliability, and the issue; and
output the factor analysis result.

18. The non-transitory computer readable medium according to claim 17,
wherein the program further causes the computer to generate a measure to improve the engagement based on the factor analysis result, and
wherein the program further causes the computer to output the measure in addition to the factor analysis result.

19. The non-transitory computer readable medium according to claim 17, wherein the program further causes the computer to acquire the reliability based on an operation history of the subject with respect to the terminal and image data of the subject.

20. The non-transitory computer readable medium according to claim 19, wherein the operation history includes an answer time for each question in the engagement survey, and
wherein the program further the computer to calculate the reliability for each question based on the answer time.
